(19) United States
(12) Patent Application Publication
(10) Pub. No.: US 2013/0304511 A1
(43) Pub. Date: Nov. 14, 2013

(54) PATIENT CARE SYSTEMS AND METHODS

(71) Applicant: Andrew Gunter, Charlotte, NC (US)

(72) Inventor: Andrew Gunter, Charlotte, NC (US)

(21) Appl. No.: 13/893,096

(22) Filed: May 13, 2013

Related U.S. Application Data
(60) Provisional application No. 61/646,063, filed on May 11, 2012.

(51) Int. Cl. G06F 19/00; G06Q 50/24

(52) U.S. Cl. CPC G06F 19/3418; G06Q 50/24
USPC 705/3

(57) ABSTRACT

Systems, method, and computer program products are provided for a patient care application. The patient care application provides for a personal reference list for patients, and healthcare providers alike. According to specific embodiments, the patient care application aids in facilitating communication between ambulatory and inpatient care settings such that a patient can track their physician and/or healthcare specialist visits and hospital admissions/discharge history via a mobile device. Likewise, a physician or healthcare professional may access patient demographics, insurance information, and healthcare admission/discharge history via the mobile device. Furthermore, the patient care application allows a physician or healthcare professional to receive or submit information pertaining to the admission of a patient via the mobile device.

### CLAIM OF PRIORITY UNDER 35 U.S.C. §119

The present application for a patent claims priority to Provisional Application No. 61/646,063 entitled “Patient Care Systems and Methods” filed May 11, 2012, and assigned to the assignees hereof and hereby expressly incorporated by reference herein.

### FIELD

In general, embodiments of the invention relate to a system for allowing patients and physicians to centralize health care provider data and provide a secure and easy way to log, track, and warehouse transitions of a patient between care providers.

### BACKGROUND

The Patient Centered Medical Home (PCMH) is a growing and accepted model for the delivery of healthcare. The core component of this model is a team approach centered on the patient and headed by a lead primary provider. Due to the enormous and complex healthcare systems which currently exist, a patient can easily lose track of their primary provider and specialist's contact information. Another one of the difficulties for patients and physicians alike in this model is the tracking of patient health care providers in both the ambulatory (e.g., outpatient) and hospital (e.g., inpatient) settings. Many existing patents seek to ease the referral process by linking to insurance company data therefore expediting claim approvals and cross referencing medical care with providers in the patient's network. Additionally, healthcare computer system models may also transmit patient insurance data and medical information to consultants to streamline patient billing and aid in patient care. These applications are primarily centered around insurance data gathering, medical data transmission, and warehousing. The patient ceases to be the focus, and with the enormity of care providers within healthcare systems, patients may lose track of the healthcare provider actually caring for them.

### SUMMARY OF THE INVENTION

The following presents a simplified summary of one or more embodiments of the present invention in order to provide a basic understanding of such embodiments. This summary is not an extensive overview of all contemplated embodiments, and is intended to neither identify key or critical elements of all embodiments nor delineate the scope of any or all embodiments. Its sole purpose is to present some concepts of one or more embodiments of the present invention in a simplified form as a prelude to the more detailed description that is presented later.

Generally, methods, apparatus systems and computer program products are described herein for a patient care system and application that provides a personal reference list for patients, and healthcare providers alike, that provides patient demographics, healthcare provider information, admission history, and other information.

Many outpatient practices may not have computer access to inpatient and urgent care or emergency department (ED) records detailing who actually provided care for their patient during a visit or admission to a medical facility. This costs the physician currently attending to the patient time and energy by forcing the physician to make phone call inquiries when a patient cannot remember who cared for them on any particular day. By having the personal reference list data available, the urgent care, ED, inpatient, and outpatient team of health care providers (e.g., doctor, physician, nurse, caregiver, etc caregivers) can send medical records (e.g. discharge summaries) to the proper primary provider and specialists, if relevant to the admission of the patient, and allow the primary provider direct points of care contacts to aid in the recovery of patient records. Furthermore, as mobile technology has continued to advance into portable devices (e.g. tablets, cellular phones, smart phones, or other like mobile devices) the expansion of applications (otherwise referred to as “apps”) for use in medicine has expanded.

Embodiments of the present invention include a mobile means to provide a personal reference list for patients and healthcare providers alike. The reference list may be utilized to improve communication between outpatient and inpatient care settings. The movement of a patient through a healthcare system may involve numerous heath care providers over a patient's lifetime including, but not limited to, physicians, nurses, home health care providers, physical therapists, speech therapists, specialists, caregivers, and dieticians, across numerous patient encounters in both the outpatient and inpatient settings. Furthermore, many hospital systems are unable to transmit data between health care providers, and thus, a log of who actually provided care can be lost in the patients visits to various medical facilities. The patient care application addresses such issues by allowing a patient to access a list of their care providers on a personal mobile device of the patient or the patient's representatives. In other embodiments the patient may allow the health care providers to access the patient care application electronically, or directly through the mobile device. Health care providers may also utilize the data to aid in facilitating and informing those in the PCMH that care has occurred. The data stored within the patient care application may also provide a log of patient encounters at varying points of care (admission history or patient care history) and therefore provide a ‘quick reference’ for the patient and healthcare provider.

In other embodiments of the invention the patient care application on a mobile device may be accessed by family members or other representatives, with the permission of the patient, in the case where a patient may be incapacitated and/or medically incapable of remembering their primary providers contact information and specialists. The present invention dramatically improves the care of patients by allowing health care providers to access information that otherwise may be unknown, difficult to identify, or impossible to identify. The access to information may also apply to facilities caring for a patient in another state, territory, country, etc., where access to the primary provider could be critical for active care, as well as for identification of follow-up after discharge.

In another embodiment of the invention the patient care application on a mobile device may be utilized by a parent or guardian for a child under their care. Designation of a child is a legal one and may be restricted with certain provisions with state and federal laws.

Embodiments of the invention relate to systems, computer program products, and methods for facilitating communication between patients and health care providers using a patient care application. The patient care application allows a user to access a patient account within the patient care application over a mobile device; provides patient demographics, wherein the patient demographics are information about a patient associated with the patient account; provides health care provider information, wherein health care provider information is information about one or more health care providers providing services to the patient; and provides patient history information, wherein the patient history information details information pertaining to the care provided by the one or more health care providers.

In further accord with an embodiment of the invention, the patient care application provides an option for the user to admit a patient; receives direction from the health care provider to admit a patient when the user wants to admit the patient into a medical facility; and receives admission information from the user regarding the admission of the patient directing the medical facility receiving the patient that the user wants the patient admitted.

In another embodiment of the invention, the patient care application provides an option to the user to discharge the patient; receives direction from the user to discharge the patient; and receives discharge information from the user.

In still another embodiment of the invention, the patient demographics, the health care provider information, the admission information, and the patient history are accessible through the mobile device to allow the one or more health care providers to share patient history information with each other.

In yet another embodiment, the demographic information comprises date of birth, patient's address, insurance company information or policy numbers, guardians name, contact numbers or addresses, or emergency phone numbers.

In further accord with another embodiment of the invention, the health care provider information comprises information about a primary provider, a nurse, a resident, a specialists, a consultant, a therapist, or an attending health care provider that is part of the health care providers involved in the care of the patient.

In another embodiment of the invention, the admission information comprises information about a location of the medical facility at which the patient is being admitted.

In still another embodiment of the invention, the admission information comprises information about a mode of transportation to a location of the facility at which the patient is being admitted, a name of the health care provider accepting the patient, or a room or bed location upon arrival of the patient.

In yet another embodiment of the invention, the patent care application automatically populates the patient demographics, the health care provider information, the admission information, the patient history, or the discharge information over a network based on information provided by the medical facility; and shares the patient demographics, the health care provider information, the admission information, the patient history, or the discharge information between the one or more health care providers over a secured shared network.

To the accomplishment the foregoing and the related ends, the one or more embodiments comprise the features hereinafter fully described and particularly pointed out in the claims. The following description and the annexed drawings set forth certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference will now be made to the accompanying drawings, which are not necessarily drawn to scale, and wherein:

FIG. 1 provides a flow diagram illustrating a method for accessing the user application, in accordance with an embodiment of the invention;

FIG. 2 provides a flow diagram illustrating a method for creating a new user account for facilitating communication between patients and healthcare providers, in accordance with an embodiment of the invention;

FIG. 3 provides a flow diagram illustrating a method for resetting a user password, in accordance with an embodiment of the invention;

FIG. 4 provides a flow diagram illustrating a method for facilitating communication between patients and healthcare providers, in accordance with an embodiment of the invention;

FIG. 5 provides a diagram illustrating a patient care system environment, in accordance with one embodiment of the invention;

FIG. 6A provides a screenshot illustrating the application facilitating communication between patients and healthcare providers, in accordance with an embodiment of the invention;

FIG. 6B provides a screenshot illustrating the application facilitating communication between patients and healthcare providers, in accordance with an embodiment of the invention;

FIG. 6C provides a screenshot illustrating the application facilitating communication between patients and healthcare providers, in accordance with an embodiment of the invention;

FIG. 6D provides a screenshot illustrating the application facilitating communication between patients and healthcare providers, in accordance with an embodiment of the invention;

FIG. 6E provides a screenshot illustrating the application facilitating communication between patients and healthcare providers, in accordance with an embodiment of the invention; and

FIG. 6F provides a screenshot illustrating the application facilitating communication between patients and healthcare providers, in accordance with an embodiment of the invention.

### DETAILED DESCRIPTION OF EMBODIMENTS OF THE INVENTION

Embodiments of the invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” As used herein a “user” refers to a patient receiving healthcare services. It should also be noted, the term “user” in addition to refereeing to a patient may refer to a representative of the patient, or a “health care provider” (e.g., doctor, physician, nurse, caregiver, etc.), and as such the term “user” may be used interchangeably throughout the specification with the other terms. Furthermore, in one embodiment, “patient” may refer to the legal guardian of a pediatric patient. Like numbers refer to like elements throughout.

Various embodiments or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

Embodiments of the present invention are described below with reference to flowchart illustrations and/or block diagrams of methods, apparatus (i.e., systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

The screenshots illustrate the application once it has been activated on a device. The process of navigation through these series of illustrations is representative of the application in its actual use. The screenshots do not represent every possible screen within the navigation of the application due to the numerous screens for every initiation of an action within the application, including but not limited to, movement of all cursors, keyboards brought up in some mobile device screens, opening and closing of data entry windows, scrolling up and down on the screen for additional areas of data, the numerous specialties that may be entered, links between external systems including email password access, external device data entry or remote downloads within IT systems, and all names are merely fictitious representations of data entry and are not to be identified to a specific person or location.

Additionally, the mobile application and functions of the application may be merged into previous existing systems and applications in varied formats. It should be noted that the mobile application both touch screen based and cursor based mobile device format may be used to navigate the application. The features, functions, and advantages that discussed herein may be achieved independently in various embodiments of the present invention or may be combined in yet other embodiments, further details of which can be seen with reference to the following description and drawings.

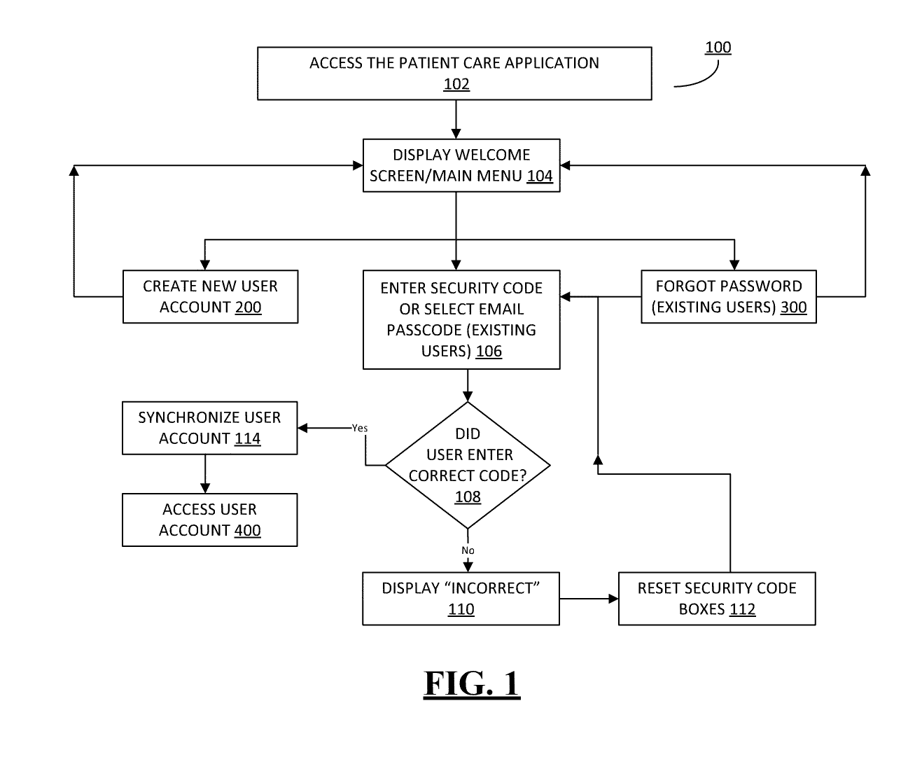

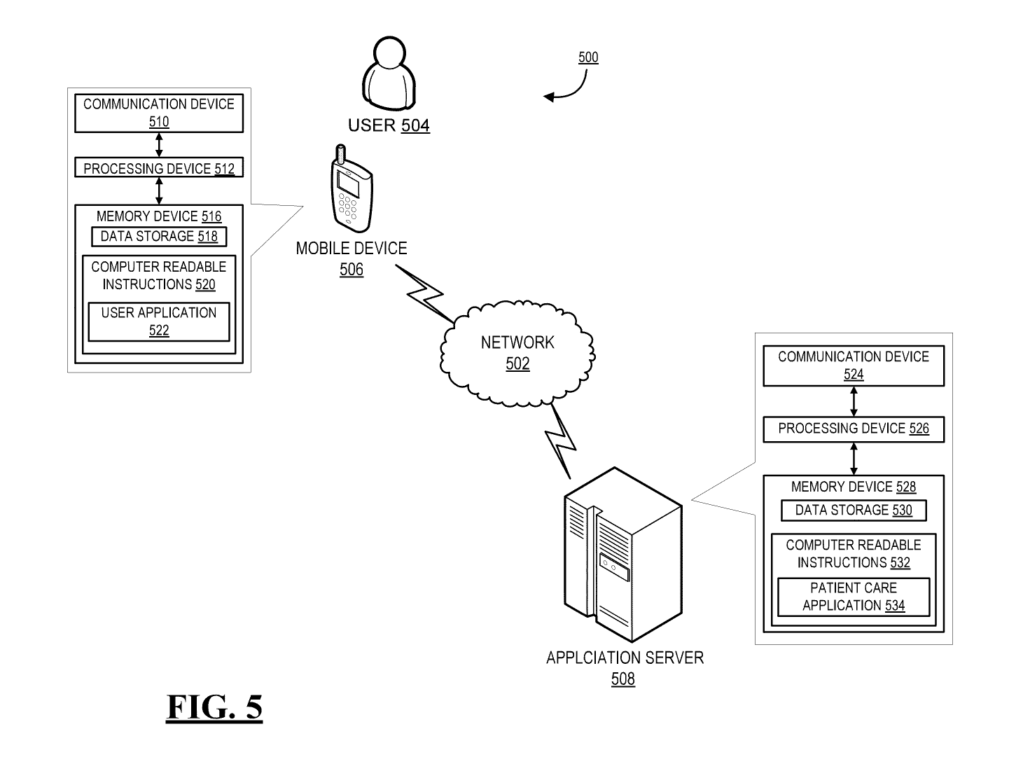

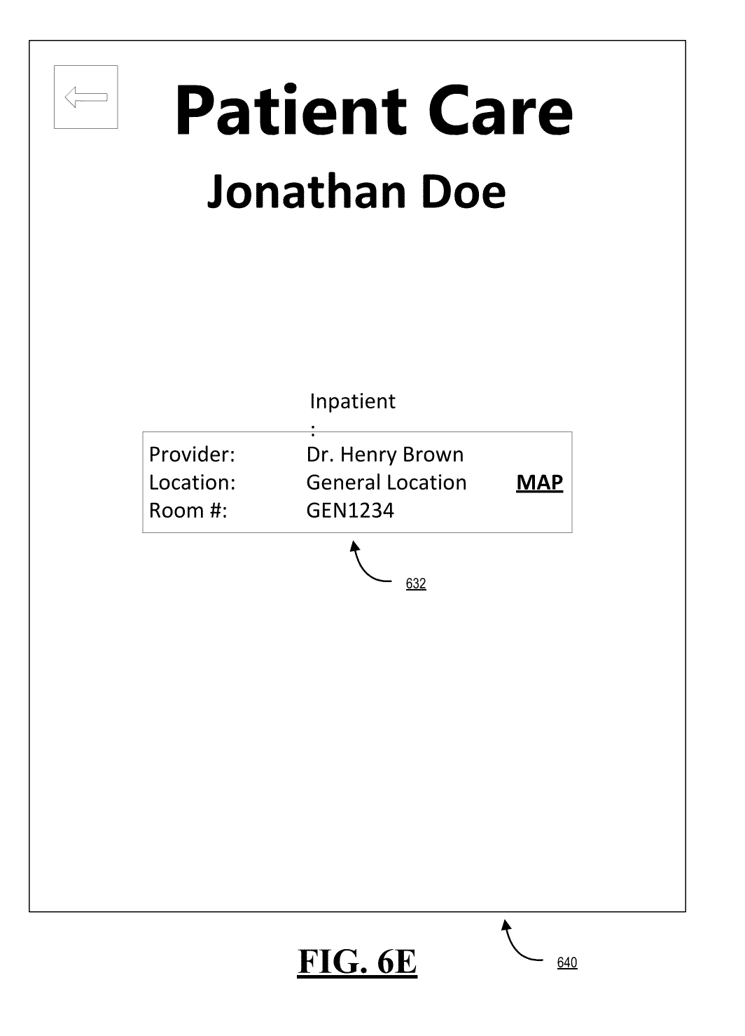

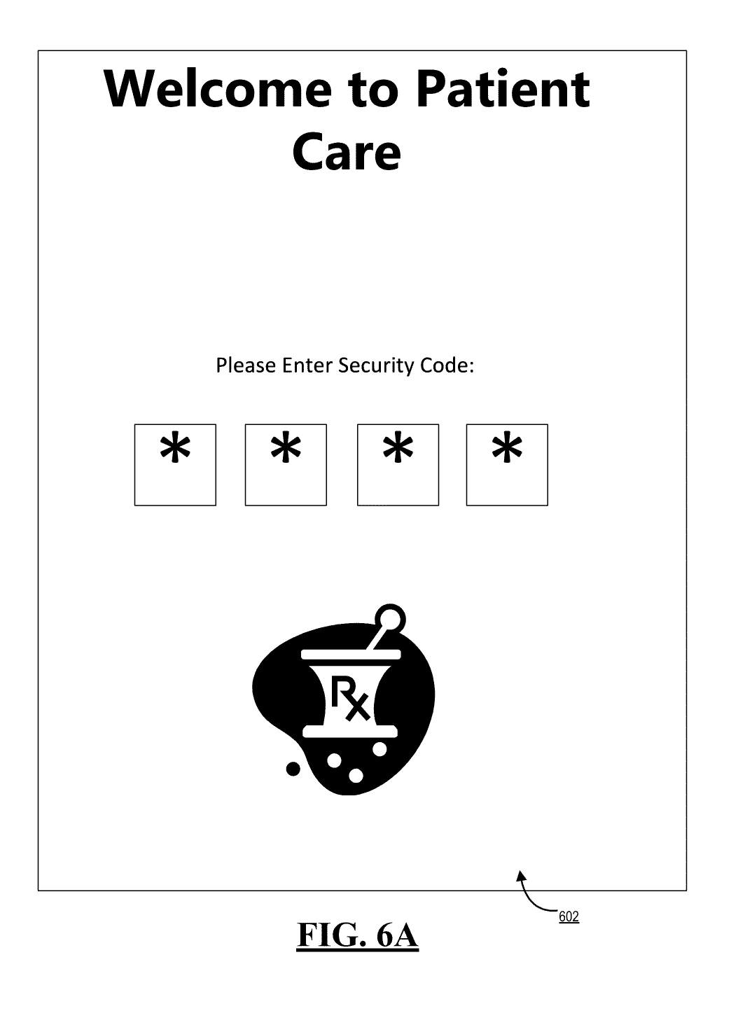

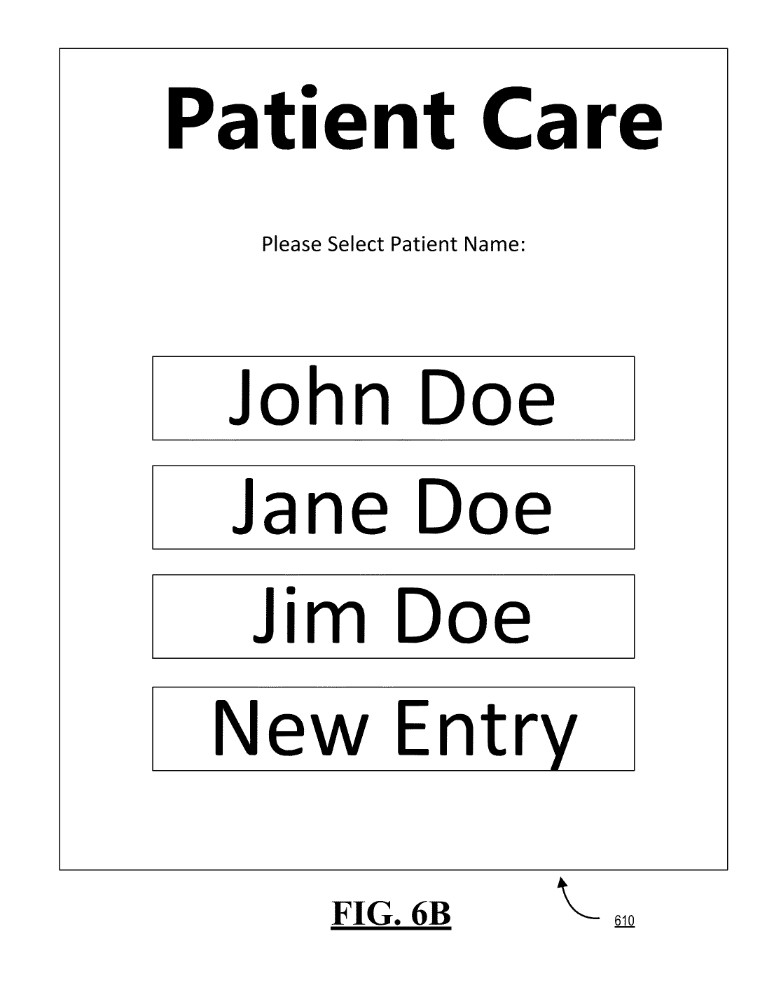

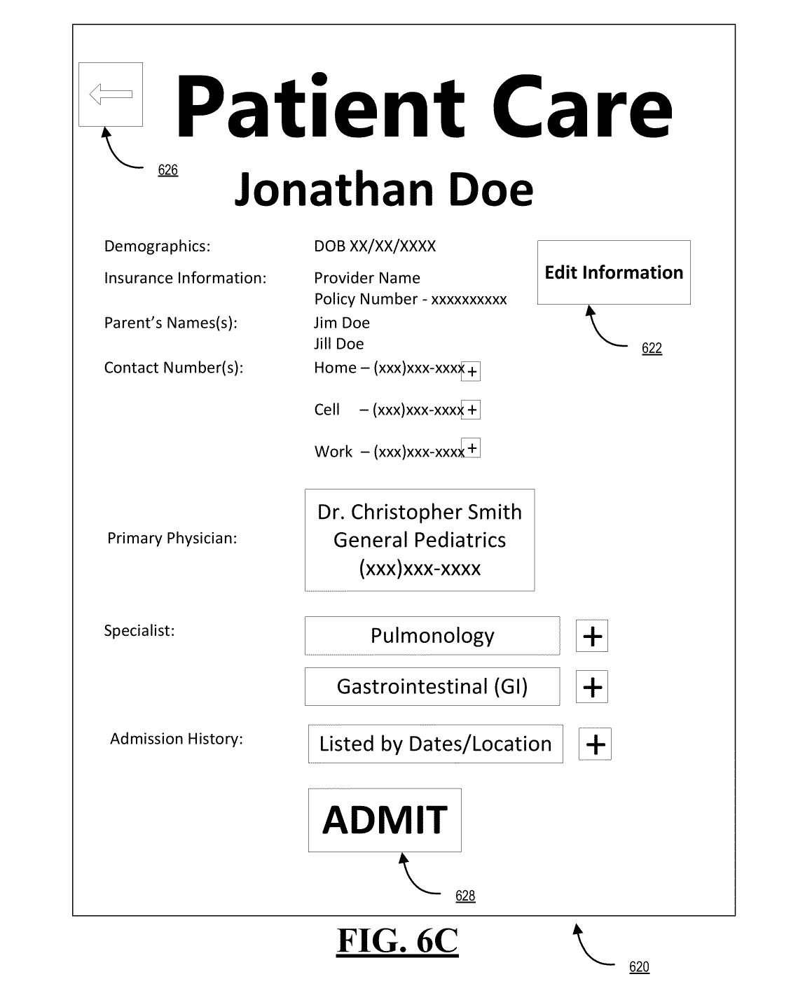

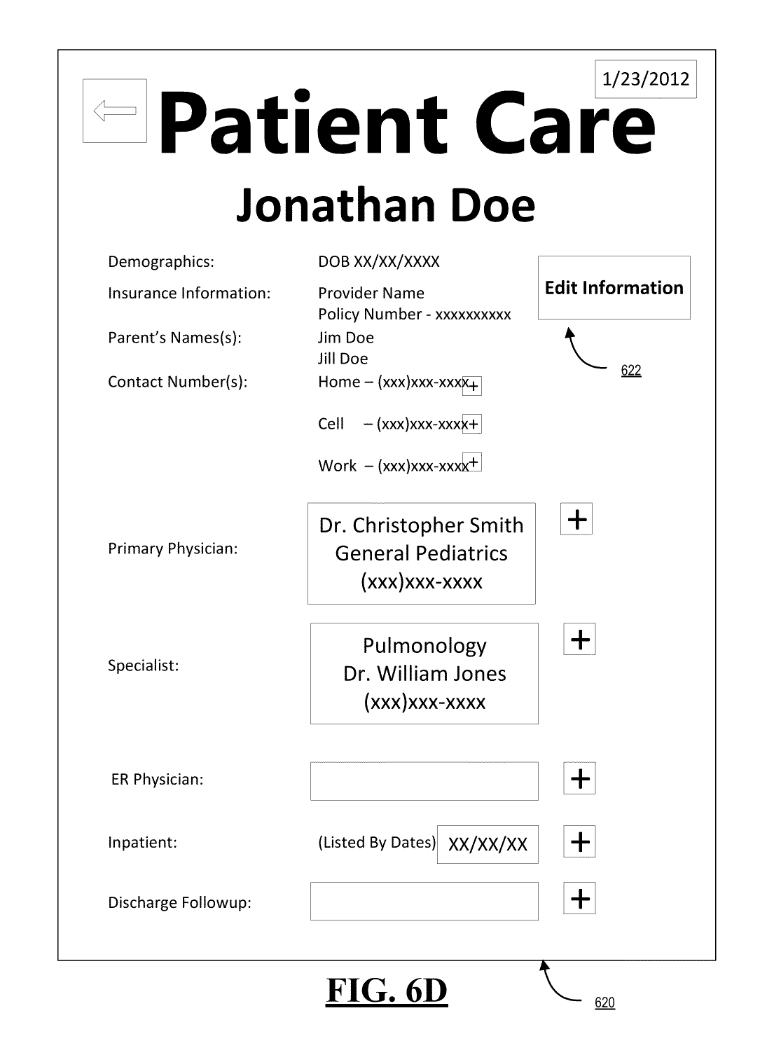

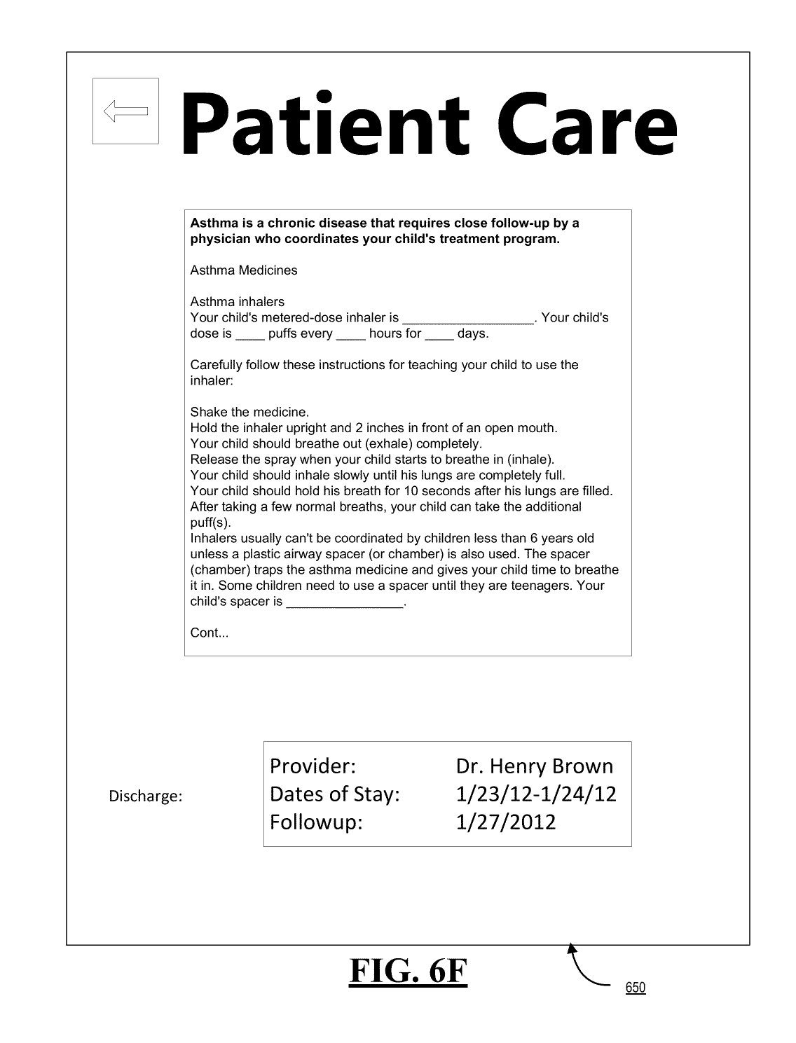

Referring now to FIGS. 1 and 5, a flowchart illustrates a method 100 for accessing the user application 522 according to the embodiments of the invention. In some embodiments of the invention the user application 522 is used to access the patient care application 534, is a portion of the patient care application 534, or is the patient care application 534 that is located on the user mobile device 506. In one embodiment, a user application 522 may be downloaded onto a mobile device 506. As illustrated by block 102, a user 504 may access the patient care application 534 through the mobile device 506. As represented by block 104, after accessing the patient care application 534, the user 504 is presented a welcome screen 602 and/or main menu displaying three distinct options for accessing a user account (e.g., a patient account). In one embodiment, the welcome screen 602 (e.g., main menu) may also display a welcome message such as “Welcome to Patient Care” (e.g., “Welcome to the Patient Care Application”), as illustrated in FIG. 6A.

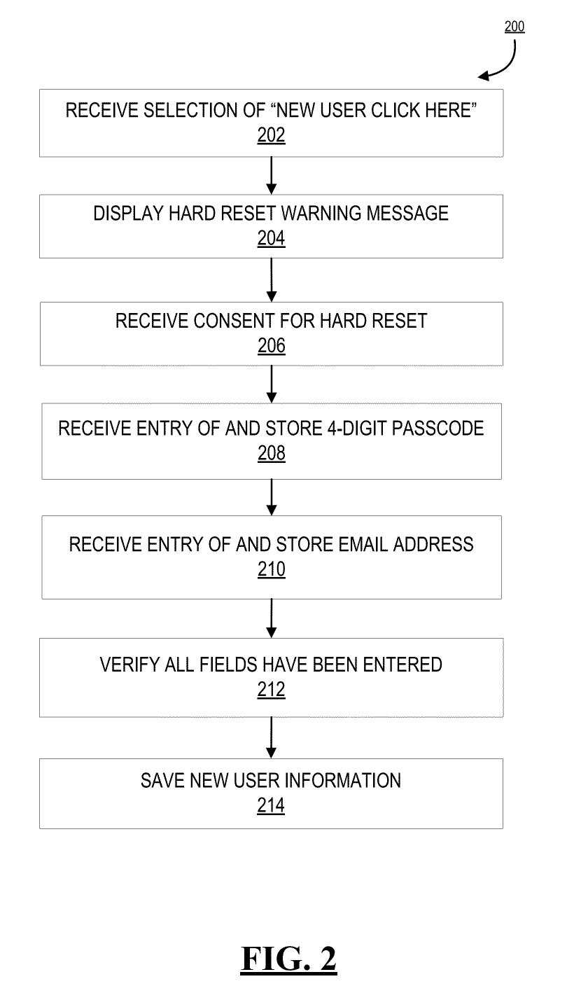

As represented by block 200 of FIG. 1, new users 504 are first given an option to create a user account. A “new user” for the purpose of this specification refers to users 504 that have not previously created user accounts. Referring now to FIG. 2, a flowchart illustrates a process 200 for creating a new user account for facilitating communication between patients and health care providers according to an embodiment of the invention. As represented by block 202, if a first time or new user 504 opens the application they are first prompted to select “New User Click Here” (or other like direction). In one embodiment, if the “New User” icon is clicked a screen is generated displaying a warning message denoting the use of this option will institute a hard reset and delete all previous application data and on the device, as illustrated by block 204. This feature is advantageous for security purposes, as it may prevent the changing of a password when data has already been stored on a mobile device 506. The user 504 is then prompted by the system to consent to the hard reset of the application. In one embodiment, if the user 504 chooses to not consent to the hard reset they will be redirected to the main menu 104. In another embodiment, as illustrated by block 206, if the user 504 agrees to the hard reset, the system will receive the consent, reset the application, and proceed with creating a new user account. In one embodiment, a legal agreement to accept conditions occurs therefore binding the user 504 of the application as the patient, the legal guardian of the patient (in the case of a minor), or power of attorney in the case of a legally incompetent patient, and informing the user 504 that the information contained within this application may be utilized or entered by any and all healthcare providers. In a specific embodiment, an acceptance of unconditional HIPAA consent for access by any providers listed within the device may be applied.

As represented by block 208, in one embodiment, the system then prompts the new user 504 to enter a 4-digit passcode (or another number of characters) for association with an account for any future opening of the application regarding data entry, modification, and viewing. The system then prompts the user 504 to repeat the entry of the 4-digit passcode for verification purposes, and subsequently stores the 4-digit passcode if it has been correctly entered. In an alternative embodiment, a passcode may be automatically generated for the user 504. As represented by block 210, the system then prompts the new user 504 to enter an email address for association with the account, which may be used to allow access to a randomly generated passcode in an instance where the password is automatically generated or has been forgotten. In one embodiment, the email address may have the option to be linked and/or require emails from resources associated with but not limited to the application and its partners. In one embodiment, a “Back” arrow may be available on one or more screens to rectify an instance where improper data has been entered.

As represented by block 212, the system then verifies that all fields have been correctly entered. In one embodiment, if all fields are not completed the system may generate a warning message and request that the user 504 provide any missing information. In another embodiment, if all fields are not completed the system can redirect the user 504 to the main menu (e.g., the welcome screen 602). As represented by block 214, once all fields have been entered and confirmed a “Save” icon may be utilized to save the user account information and the system is redirected to the main menu (e.g., the welcome screen).

Alternatively, as represented by block 300 in FIG. 1, existing users 504 that may not remember their password/security code are given the option to reinstate a new security code. An “existing user” for the purpose of this specification refers to users 504 that have previously created user accounts. It should be noted that the terms “existing user” and “repeat user” may be used interchangeably throughout the specification as a user 504. It should also be noted that the terms “password”, “security code”, and “passcode” may be used interchangeably throughout the specification, and therefore should be interpreted as having the same meaning, unless explicitly stated otherwise.

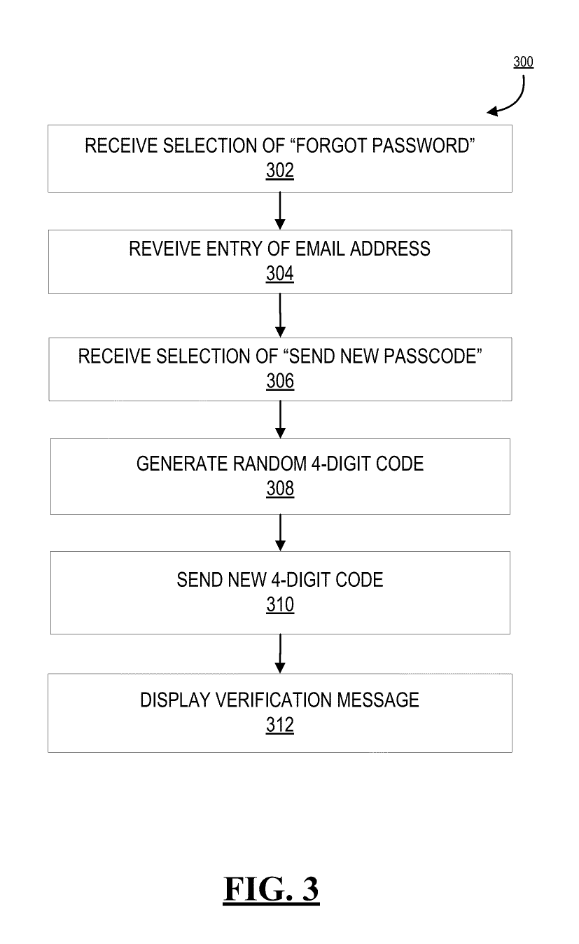

Referring now to FIG. 3, a flowchart illustrates a process 300 for retrieving a new password according to an embodiment of the invention. As represented by block 302, the user 504 is first prompted to select the “Forgot Password” option. In one embodiment, at the bottom of the main menu, an area to click on “Forgot Password” is available. After selecting the “Forgot Password” option the system may then prompt the user 504 to enter the email address associated with the user account, as illustrated in block 304. In one embodiment, the system may present the message “Enter Email Address Associated with this Mobile Device” (or other like message) and a free text area where the user 504 may enter an appropriate email address. In an alternative embodiment, the patient may re-access stored data if a passcode is forgotten through a series of security questions. After an email address has been entered or the user 504 has been verified, the system may then prompt the user 504 to select the “Send New Passcode” option from within the application, as illustrated by block 306. The system then cross-references the email address to verify it is associated with an address previously entered. If the email address is confirmed the system then generates a random 4-digit passcode, as illustrated by block 308, and emails the new passcode to the user 504, as illustrated by block 310. After sending the email, the system then presents a verification message and defaults to the main menu. In one embodiment, the system may present a verification message stating “Email Sent to [Sample E-mail Address]”. The application program links the emailed passcode to the user application 522 to allow the user 504 to enter the emailed passcode, as illustrated by block 106.

In instances after creating a new user account, as illustrated by block 200, or retrieving a new security code, as illustrated by block 300, the user 504 will be redirected to the main menu (e.g., welcome screen 602) and prompted to enter their security code prior to accessing their user account.

Returning to FIG. 1, as represented by block 106, a security code may be entered for all existing users 504. In one embodiment, each digit entered is displayed as an asterisk in 4 boxes (or any other number of characters), as illustrated in the welcome screen 602 of FIG. 6A. The system then checks to verify whether or not a correct code has been entered by the user 504, as illustrated by block 108 of FIG. 1. If the system verifies a correct code has been entered, the user account may be synchronized with any previously stored information on a plurality of devices, as illustrated by block 114 in FIG. 1. The user 504 is then granted access to their user account, as illustrated by block 400 in FIG. 1. In an instance when an incorrect code has been entered the system may display a message informing the user 504 that an incorrect code has been entered, as illustrated by block 110 in FIG. 1. In one embodiment, a box in red (or another color) may flash “Incorrect” (or another like indication) and the security code boxes may be reset, as illustrated by block 112 in FIG. 1.

In other embodiments of the invention health care providers may also have the ability to access the patient care application 534 that a the health care provider may be able to access from another computing device over the network. In this way, if the patient (or a representative of the patient) is not able to access the patent care application 534 to provide information to a health care provider, the health care provider may have other ways of access the information. In still other embodiments, the health care provider may be able to access only the patent care application 534 on the patient's mobile device using a specialized interface and security code for the health care provider.

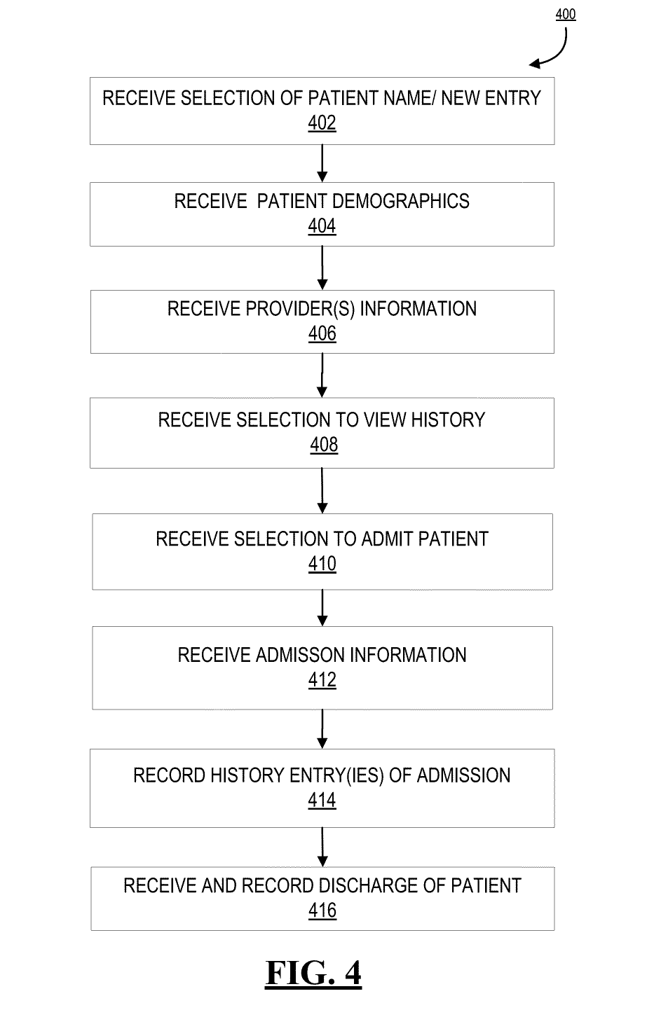

Referring now to FIG. 4, a flowchart illustrates the process 400 for facilitating communication between patients and healthcare providers according to an embodiment of the invention. As represented by block 402, once the proper passcode has been entered into the application (or a new account has been set up, etc.) the “Select Patient Name” interface 610 (or other like interface) appears, as illustrated in FIG. 6B. In one embodiment, where the user 504 is a new user, only a ‘New Entry’ icon may be displayed. In another embodiment, where the user 504 is a repeat user, any previously entered patient names may be displayed, for example, when the user 504 is a guardian, attorney with guardianship rights, a physician, etc. with multiple patients. In one embodiment, information referring to a patient name associated with multiple devices may be synchronized with the one or more devices upon the selection of the patient name. In another embodiment, information referring to a patient name on multiple devices may be synchronized on the one or more device simultaneously as the information is edited. For example, if two guardians have access to one child's patient care information on their mobile device, the information edited on the first guardians mobile device may be synchronized with the application server, as a result, the information on the second guardians mobile device may be updated to reflect the changes.

As represented by block 404, after a patient name has been selected, the user 504 may modify the patient's demographics in a demographics screen 620 as seen in FIGS. 6C and 6D. Demographic modification may include editing, viewing, selecting, and/or the like. In one embodiment, where the user 504 is a new user creating a new entry, all of data in the demographics screen 620 may be blank, and thus, the new user may enter the demographic information at this time. The demographics screen 620 may include, but is not be limited to, date of birth, patient's address, insurance company information and policy numbers, the parent/guardians name(s) (e.g., in the case of a minor), contact numbers and addresses, and emergency phone numbers. In one embodiment, additional data may be entered or edited using the Edit Information Icon 622, as illustrated in FIGS. 6C and 6D. In one embodiment, after all the data has been entered by the user 504 of the application a ‘continue arrow’ may be selected to process to the next screen, or scrolling on the screen may be utilized.

As represented by block 406, following the entry of patient demographics, the user 504 may enter corresponding health care provider information for the patient. As illustrated in FIG. 6C, in one embodiment, health care provider information may be entered on the same screen as the patient demographics. In another embodiment, the user 504 may be redirected to a provider screen to enter provider information. Data entry for provider information may include but not be limited to primary provider(s), specialists, and/or the like as described herein. In one embodiment, the primary provider is the patient's central care provider for the patient's health care. In another embodiment, the primary provider may reference the main health care provider that the patient sees on an ambulatory or outpatient basis. The term health care provider is used as not all primary care providers are physicians, such as, nurse practitioners, physician assistants, emergency medical technicians (EMTs). In one embodiment, the listing of such information may be added from a scrolled selection. For example, the user 504 may add any other providers of health care and contact information they wish to include by a scrolling list of categories including, but not limited to, all subspecialist categories (pulmonologist, cardiologist, endocrinologist, allergist, immunologist, etc.), home health, nutritionists/dieticians, therapists (physical, speech, and occupational), and integrated/alternative (acupuncturists, chiropractors, etc.). In another embodiment the listing of such information may be added using a free text field. For example, as the data entry portion for this can be difficult for patients, healthcare providers may also enter in this data manually on the patient's mobile device with permission. In yet another embodiment, the listing of such information may be added using either a scrolled selection or a free text field. In one embodiment, all data and demographics edited in these sections are automatically recorded and saved.

In one embodiment, an “Admission History” icon 624 (or other like patient care history feature) may exist, where if selected the user 504 may view all previous hospitalizations of the patient or other appointments, as illustrated in block 408 of FIG. 4. The admission history, in some embodiments, may illustrate the date, time, location, heath care provider, reason for admission, disposition for admission, medication provided, etc. for each of the patient's hospitalizations or other appointments for the patient.

In one embodiment, one or more pages may have a “Go Back” icon 626, to leave the current page and restore the previous page. As illustrated by FIG. 6C, the “Go Back” icon may be illustrated using a backwards arrow. In one embodiment, if the “Go Back” icon 626 is selected the data entered will automatically be saved.

As represent by block 410 of FIG. 4, a provider may select an “ADMIT” icon 628 if the patient is to be admitted to a hospital or other like facility. For example, when this data entry point is accessed by the patient, or in other embodiments the care provider, data may be entered for the patient's admission to an urgent care, emergency department (“ED”), or inpatient setting. As represented by block 414 of FIG. 4, once the “ADMIT” icon 628 option has been selected a “History” entry may be recorded indicating the date, time, location, care provider admitting the patient, etc. In one embodiment, the system may denote that a history entry is being recorded on the screen throughout the admission process. It should be noted that for the purpose of this illustration the “Admission History” icon 624 is presented prior to admitting a patient 410 but may be selected at any time after selecting a patient name. In one embodiment, the “Admission History” icon 624 may be selected after the history entry is recorded. In one embodiment, if the mobile device turns off at any time that the application is running it may default to the passcode screen 602, and a screen area for “View History” of admissions may also be available to view previous data that was saved before the mobile device turned off.

In one embodiment, the selection of the “ADMIT” icon 628 may bring up additional icons for data entry, as illustrated in FIG. 6D. These icons include but are not limited to ER, Inpatient, Discharge, and/or the like. The user 504 or their physician may then modify these fields to specify additional admission information, as illustrated in block 412 of FIG. 4. In one embodiment, there may be a secure confirmation notification at each access point during an admission. This may include, but not be limited to, check boxes that highlight with a green check (or other color and/or icon) when the patient arrives at a given point of care (e.g., Urgent Care, ED, and Floor of a hospital). This secure confirmation may be manually entered by the user 504, care provider, or may be automated through a transmitted data steam within a healthcare site. In another embodiment of the mobile application, the list of health care providers during an Urgent Care/ED/inpatient stay may include, but are not be limited to nurses, residents, specialists/consultants, therapists, and attendings. Additionally, in one embodiment, the lead health care provider may be highlighted graphically.

In one example, if a primary care physician were to call and speak to an Emergency Room Provider they may fill text data into the ER field. This data may include, but not be limited to, the ED provider's name, address of the emergency department, address and phone number of the facility, and a map link. In this way, when the patient arrived at the ED to check in, the patient may show the attending health care provider all of the details entered by the primary care physician in order to speed up the check in process. The attending health care provider need only view the instructions from the primary care physician (including the identity of the Emergency Room Provider) in order to identify why the patient is there and where/who the patient should be directed. In one embodiment, there may be optional ‘map links’ (e.g., links to electronic maps and direction providers) that provide directions to different facilities. This could aid the user 504 by providing the location of specific sites of care for a patient being transported between geographic locations, which may include facilities, buildings, floors, rooms, or the like.

In an urgent care or emergency department transfer this data may further include, but is not limited to, the hospital the patient is being transported to, the mode of transportation (ambulance, car, etc.), the name of the physician who is accepting/taking care of the patient, and potentially the room and bed location upon arrival. A transport team (e.g. EMT crew) could also view this information to reaffirm the patients name, demographics, destination for transport, and in-route physician to contact if the patient's condition deteriorates. In one embodiment, an emergency override for medical providers may be available in the case of an incapacitated patient with no identification of care providers available through other means. In still other embodiments, the information in the patient care application 534 may be e-mailed to the medical facility before the arrival of the patient.

In one example, upon arrival to the urgent care or ED, the patients demographics may be confirmed by the triage/intake nurse by viewing the patient care application 534 (at the patient's login or discretion). The patient care application 534 may also confirm the health care provider (e.g., by name, etc.) that accepted the patient for care from the primary physician, and reassure all parties involved the patient is in the correct location. Additionally, the urgent care or ED care provider may access the patent's information, at the patient's discretion, and view the patient's primary provider and specialists. The ability to access patient information through the patient care application 534 dramatically improves patient care in the respect that specific health care providers for the patient may be contacted that have the greatest knowledge of the patient's history and improve communication between providers in the acute care and ambulatory setting. Communication between health care providers may be critical for medical decisions and help put the patient at ease with the knowledge his primary provider and specialists are accessible if needed. In another example, after the patient is cared for, the information entered into the patient care application 534 may be secured, based on a patient's login and password. The patient care application 534 keeps a record by date and location that may be accessed for potential future communication between the patient and the health care provider in the urgent care or ED, as well as provide a log of contacts for the primary provider if further discussion of the patient's care is needed after discharge. In one example, the logged data may be utilized by the primary provider for viewing the frequency of admissions and alter the care of the patient if needed.

In one embodiment, for a transfer of a patient to an inpatient setting the data entry may include, but not be limited to, the hospital the patient is being admitted to, the mode of transportation, the name of the physician who is accepting care for the patient upon admission, and the floor/bed location to which the patient is being admitted. This information allows the patient to know exactly where he is going, therefore allowing them to communicate to family members if necessary and to know specifically the health care providers taking care of him.

In one embodiment of the invention, the mobile patient care application 534 provides a secured shared sync between mobile devices or systems, such that patient information may be shared between primary care providers, specialists, or other health care providers. The user 504 may determine what health care providers have access to the patient information in advance, and as such, in the event that the user 504 is not able to provide access to the mobile device, the health care providers may access the information from the health care providers own systems. Furthermore, a notification of an admission and the exact location of a patient may be shared between parents and health care providers, over the secure network.

In one embodiment, the inpatient care provider(s) may access patient information, at the patient's discretion, and view the patient's primary provider and specialists. This feature may dramatically improve patient care in the respect that specific health care providers for the patient may be contacted, or otherwise consulted when necessary, that have the greatest knowledge of the patient's history, and thus, improve communication between providers in the inpatient and ambulatory setting. Communication between inpatient and ambulatory care providers may be critical for medical decisions and help put the patient at ease with the knowledge the patient's primary provider and specialists are accessible if needed. In one example, living wills or “do not resuscitate” instructions may be accessible from the patent care application, in the case of incapacitation of the patient.

Additionally, during any hospital stay the inpatient care provider may change based on on-call instructions, weekends, holiday coverage, etc.) and a patient may not remember the one or more health care providers that actually took care of him or her on a given day of hospitalization. Furthermore, in another embodiment, a list of care providers by date may also be included in the patient care application 534.

In one embodiment, the mobile device data may be manually updated by the providers caring for the patient, and thus, maintain a running log of the care providers involved during a given admission. In another embodiment, a provider may utilize a secure server to send data to the patient's mobile device from the provider's mobile device, desktop computer, tablet, or other device over the network. In another embodiment, the mobile device may interact with a particular healthcare system of the healthcare provider, where the system may use Bluetooth, RFID, WIFI, and the like to push information to the user's 504 patient care application 534 on the mobile device. In another embodiment, there may be a secure auto-population of the health care provider information into a patient account based on the ‘location’ of the health care provider in relation to the patient. This type of communication may require a local Wi-Fi site, GPS location, or near field communication that triggers a download of health care provider, medical facilities, etc. information. For example, in one embodiment each time the patient enters a primary care provider's location (e.g., address, building, floor, etc.) the data about the facility or primary care provider may be automatically downloaded. In some embodiments the patient may be required to accept the download on a queued interface. This feature may save the user 504 or health care provider time by not having to enter the information manually and may prevent incorrect information from being entered. In another embodiment, the user 504 may receive a notification from a location determining service, such as GPS, indicating the location of the user 504 and inquiring whether or not the user 504 wants to log their location in the patient care application 534, where the location may be associated with a particular patient admission, discharge location, follow-up appointment, physician, and the like. In yet another embodiment, the location determining service may auto populate location fields with the user's current location, based on a location determining device or service. Furthermore, after the patient is discharged from the inpatient facility the data would remain secure, based on a patient's login and password, and would keep a record of the admission by date and location. In one example, the patient may be directly admitted to a floor of the hospital though an inpatient selection screen 630. The patient or the provider may enter the data into the inpatient field 632 to give the patient real time information on where they are going and a map link of how to get there, as illustrated in FIG. 6E.

In one embodiment, the data of admissions may be securely downloaded and backed up on a patient's home computer for quick reference, because of mobile device storage limitations, or for long term storage purposes, or unintentional hard reset occurrences. In another embodiment, the data of admissions may be securely and remotely sent to a warehousing data center or cloud computing center for access when data storage on the mobile device is limited or long-term storage is necessary. Furthermore, since the data may be synced between phones the patient history or the patent location may be accessed by other users (e.g., family members, care givers, care provider, friends) to which the patient wants to allow access. Moreover, the patient may be allowed to e-mail the information in the patent care application to other users.

In one embodiment, the admission log, through the patient's login and password, may be accessed for active and future communication between the patient and the health care providers during an inpatient stay, as well as provide a log of contacts for the primary provider if further discussion of the patient's care is needed after discharge. In another embodiment, the logged data may also be utilized by the primary provider to view the frequency of admissions and alter the care of the patient if needed.

In one embodiment, the user 504 may enter other health care providers by using an “Add New” (or the like) icon in the patient care application 534. The new provider information is important as health care providers shift and providers change during the course of any given hospital stay. In one embodiment, the ‘New’ provider data may be recorded by the date upon which the data was entered and may default to the original entered data (location, specialty, room#, etc.). The provider data entered may include, but is not limited to, name, specialty, location, room #, and other health care providers such as ‘today's nurse’. In one embodiment, the inpatient data lines are expandable and collapsible. In another example, providers may also utilize the demographics data, primary provider, and specialist data, with the patient's permission to contact a patient's personal physician and specialists if the need were to arise and to improve communication between the health care providers.

In one embodiment, at the end of a hospitalization the patient's provider may click on a ‘Discharge Patient’ icon, or the like, in order to record information regarding the end of the patient's care from a particular health care provider. In one embodiment, the patient care application 534 may include the date of discharge, limit further data entry for previous fields within the application not related to discharge, and only allow for additional data to be entered regarding the patient's discharge. In another embodiment, all fields for discharge must be entered. Patient discharge fields may include, but are not limited to, discharge provider, hospital/facility of discharge, length of stay, and follow-up appointment date, place, and time. In one embodiment, the patient discharge fields may be automatically populated. In another embodiment, the patient discharge fields may be manually entered. In one embodiment, a “Save” option may be selected, such that a summary with expandable and collapsible windows may be displayed to the user 504. Furthermore, as illustrated in FIG. 6F the discharge interface may include, but is not limited to patient information, medication information, discharge specific education, health care provider recommendations, and discharge information. Discharge information may include, but is not be limited to, the discharge physician, dates of admission, follow-up name, location, date, and time. In another embodiment, the follow-up appointment may be linked to a mobile device calendar and/or reminder.

In one embodiment, the discharge interface may be identical to what appears if the “View History” option 408 is selected. This view may include, but is not be limited to, inpatient information such as admission dates, discharge dates, and locations, outpatient information such as primary provider, specialists, and date last edited. In one embodiment, if the admissions are selected they are expanded and/or collapsed to view all entered data for that admission. In one embodiment, once the process has been completed a “Back To Main Menu” icon may be highlighted, such that the viewer may be redirected back to the Main Menu and a passcode must be re-entered to view additional information on additional patients. The data related to all of a patient's admissions may be key for both patient care and communication between providers.

In one embodiment “Living Wills” or a “Do Not Resuscitate” request may be accessible in the case of incapacitated patient or due to a lack of knowledge of end of life wishes by the guardian. Due to the sensitive nature of this information this data may be required to be updated periodically and the application may request an update intermittently. Furthermore, additional security measures may be required to change the living will or do not resuscitate requests, such as multiple witnesses, passwords, notarization, etc.

In one embodiment the patient care application 534 may be integrated with existing information technology systems within a healthcare system or data network.

In one embodiment, and in agreement with HIPPA laws, medical information including but not limited to diagnostic tests, laboratory data, and diagnoses may be integrated within the application for a quick view. In another embodiment this medical information may be a part of the admission and discharge record within the history section.

As will be appreciated by one of ordinary skill in the art in view of this disclosure, the invention may include and/or be embodied as an apparatus (including, for example, a system, machine, device, computer program product, and/or the like), as a method (including, for example, a business method, computer-implemented process, and/or the like), or as any combination of the foregoing. Accordingly, embodiments of the invention may take the form of an entirely business method embodiment, an entirely software embodiment (including firmware, resident software, micro-code, etc.), an entirely hardware embodiment, or an embodiment combining business method, software, and hardware aspects that may generally be referred to herein as a “system.” Furthermore, embodiments of the invention may take the form of a computer program product that includes a computer-readable storage medium having one or more computer-executable program code portions stored therein. As used herein, a processor, which may include one or more processors, may be “configured to” perform a certain function in a variety of ways, including, for example, by having one or more general-purpose circuits perform the function by executing one or more computer-executable program code portions embodied in a computer-readable medium, and/or by having one or more application-specific circuits perform the function.

FIG. 5 illustrates a patient care system environment, in accordance with one embodiment of the invention. As illustrated in FIG. 5, one or more mobile devices 506 are operatively coupled, via a network 502 to an application server 508, and/or various health care provider computer systems (not illustrated). In this way one or more users 504 may connect to the application server to run the patient care application 534, and/or connect to the various health care provider computers systems to share patient information between health care providers, as previously explained above.

The network 502 may be a global area network (GAN), such as the Internet, a wide area network (WAN), a local area network (LAN), or any other type of network or combination of networks. The network 502 may provide for wireline, wireless, or a combination of wireline and wireless communication between devices on the network 502.

As illustrated in FIG. 5, a user 504 accesses the patient care application 534 through the mobile device 506. The mobile device 506 in some embodiments may include a laptop, tablet, mobile device, smartphone device, or any other type of mobile computing device that generally comprises a communication device 510, a processing device 512, and a memory device 516.

As used herein, the term “processing device” generally includes circuitry used for implementing the communication and/or logic functions of a particular system. For example, a processing device 512 may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 512 may include functionality to operate one or more software programs based on computer-readable instructions 520 thereof, which may be stored in data storage 518 within a memory device 516.

The processing device 512 is operatively coupled to the communication device 510 and the memory device 516. The processing device 512 uses the communication device 510 to communicate with the network 502 and other devices on the network 502, such as, but not limited to, the application server 508, and/or the health care provider computer systems (not illustrated). As such, the communication device 510 generally comprises a modem, server, or other device for communicating with other devices on the network 502 and/or a keypad, keyboard, touch-screen, touchpad, microphone, mouse, joystick, other pointer device, button, soft key, and/or other input device(s) for communicating with the user 504. As further illustrated in FIG. 5, mobile devices 506 may have computer-readable instructions 520 stored in the memory device 516, which in one embodiment includes the computer-readable instructions of user applications 522 (e.g., web browser, a portion or all of the patient care application 534, etc.). In some embodiments, the memory device 516 includes data storage 518 for storing data related to the mobile device 512, including but not limited to data created and/or used by the user application 522. The user application 522 may be used by the users 504 to access the patient care application 534 located on the application server 508, and/or health care provider information, hospital information, etc. located on health care provider systems (not illustrated) for entering, viewing, editing, and/or sharing information about the patient and the patients health care providers. In some embodiments, the user application 522 may be all or a part of the patient care application 534 that may be located on the mobile device 506. In other embodiments the patient care application 534 may be partially located within the mobile device 506 and partially located on the application server 508.

As illustrated in FIG. 5, the application server 508 generally comprises a communication device 524, a processing device 526, and a memory device 528. The processing device 526 is operatively coupled to the communication device 524 and the memory device 528. The processing device 526 uses the communication device 524 to communicate with the network 502 and other devices on the network 502, such as, but not limited to, the mobile device 506, and/or health care provider systems (not illustrated). As such, the communication device 524 generally comprises a modem, server, or other device for communicating with other devices on the network 502.

As further illustrated in FIG. 5, the application server 508 comprises computer-readable instructions 532 stored in the memory device 528, which in one embodiment includes the computer-readable instructions 532 of a patient care application 534. In some embodiments, the memory device 528 includes data storage 530 for storing data related to the patient care application 534, including but not limited to data created and/or used by the patient care application 534. The patient care application 534, as previously described is used to enter, view, edit, share, etc. information about the patient and the health care providers associated with the patient. In some embodiments of the invention, the portion of the patient care application 534 that is stored on the application server 508 is only a portion that is used to back up and store the information received and entered into the portion of the patient care application 534 stored on the mobile device 506.

The health care provider systems (not illustrated) may contain devices, applications, etc. that are the same or similar to the mobile device 506 and/or the application service 508 in order to allow for a secure connection to transmit information about the patient and/or health care provider over the network 502. In one embodiment, the application may be integrated with existing information technology systems within a healthcare network.

A computer program may be utilized to implement all or parts of the invention through the use of systems like those illustrated in the figures and described above. The computer program may take the form of a computer program product, including executable code, residing on a computer usable or computer readable storage medium. Such a computer program can be an entire application to perform all of the tasks necessary to carry out the invention, or it can be a macro or plug-in which works with an existing general purpose application such as a spreadsheet or database program. A tangible medium may be used, but note, however, that the “medium” may also be a stream of information being retrieved when a processing platform or execution system downloads the computer program instructions through the Internet or any other type of network.

It will be understood that any suitable computer-readable medium may be utilized. The computer-readable medium may include, but is not limited to, a non-transitory computer-readable medium, such as a tangible electronic, magnetic, optical, electromagnetic, infrared, and/or semiconductor system, device, and/or other apparatus. For example, in some embodiments, the non-transitory computer-readable medium includes a tangible medium such as a portable computer diskette, a hard disk, a random access memory (RAM), a read-only memory (ROM), an erasable programmable read-only memory (EPROM or Flash memory), a compact disc read-only memory (CD-ROM), and/or some other tangible optical and/or magnetic storage device.

One or more computer-executable program code portions for carrying out operations of the invention may include object-oriented, scripted, and/or unscripted programming languages, such as, for example, Java, Perl, Smalltalk, C++, SAS, SQL, Python, Objective C, and/or the like. In some embodiments, the one or more computer-executable program code portions for carrying out operations of embodiments of the invention are written in conventional procedural programming languages, such as the “C” programming languages and/or similar programming languages. The computer program code may alternatively or additionally be written in one or more multi-paradigm programming languages, such as, for example, F#.

The one or more computer-executable program code portions may be stored in a transitory and/or non-transitory computer-readable medium (e.g., a memory, etc.) that can direct, instruct, and/or cause a computer and/or other programmable data processing apparatus to function in a particular manner, such that the computer-executable program code portions stored in the computer-readable medium produce an article of manufacture including instruction mechanisms which implement the steps and/or functions specified in the flowchart(s) and/or block diagram block(s).

The one or more computer-executable program code portions may also be loaded onto a computer and/or other programmable data processing apparatus to cause a series of operational steps to be performed on the computer and/or other programmable apparatus. In some embodiments, this produces a computer-implemented process such that the one or more computer-executable program code portions which execute on the computer and/or other programmable apparatus provide operational steps to implement the steps specified in the flowchart(s) and/or the functions specified in the block diagram block(s). Alternatively, computer-implemented steps may be combined with, and/or replaced with, operator- and/or human-implemented steps in order to carry out an embodiment of the invention.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations, modifications, and combinations of the just described embodiments can be configured without departing from the scope and spirit of the invention. Therefore, it is to be understood that, within the scope of the appended claims, the invention may be practiced other than as specifically described herein.

What is claimed is:

1. A system for facilitating communication between patients and health care providers, the system comprising:
a memory device configured to store computer-executable code; and
a processing device in communication with the memory device and configured to execute computer-executable code stored on the memory device to:
allow a user to access a patient account within a patient care application over a mobile device;
provide patient demographics, wherein the patient demographics are information about a patient associated with the patient account;
provide health care provider information, wherein health care provider information is information about one or more health care providers providing services to the patient; and
provide patient history information, wherein the patient history information details information pertaining to the care provided by the one or more health care providers.

2. The system of claim 1, wherein the processing device is further configured to execute computer-executable code stored on the memory device to:
provide an option for the user to admit a patient;
receive direction from the health care provider to admit a patient when the user wants to admit the patient into a medical facility; and
receive admission information from the user regarding the admission of the patient directing the medical facility receiving the patient that the user wants the patient admitted.

3. The system of claim 1, wherein the processing device is further configured to execute computer-executable code stored on the memory device to:
provide an option to the user to discharge the patient;
receive direction from the user to discharge the patient; and
receive discharge information from the user.

4. The system of claim 1, wherein the patient demographics, the health care provider information, the admission information, and the patient history are accessible through the mobile device to allow the one or more health care providers to share patient history information with each other.

5. The system of claim 1, wherein the demographic information comprises date of birth, patient's address, insurance company information or policy numbers, guardians name, contact numbers or addresses, or emergency phone numbers.

6. The system of claim 1, wherein the health care provider information comprises information about a primary provider, a nurse, a resident, a specialists, a consultant, a therapist, or an attending health care provider that is part of the health care providers involved in the care of the patient.

7. The system of claim 2, wherein the admission information comprises information about a location of the medical facility at which the patient is being admitted.

8. The system of claim 2, wherein the admission information comprises information about a mode of transportation to a location of the facility at which the patient is being admitted, a name of the health care provider accepting the patient, or a room or bed location upon arrival of the patient.

9. The system of claim 1, wherein the processing device is further configured to execute computer-executable code stored on the memory device to:
automatically populate the patient demographics, the health care provider information, the admission information, the patient history, or the discharge information over a network based on information provided by the medical facility; and
share the patient demographics, the health care provider information, the admission information, the patient history, or the discharge information between the one or more health care providers over a secured shared network.

10. A computer program product, the computer program product comprising at least one non-transitory computer-readable medium having computer-readable program code portions embodied therein, the computer-readable program code portions comprising:
an executable portion configured for allowing a user to access a patient account within a patient care application over a mobile device;
an executable portion configured for providing patient demographics, wherein the patient demographics are information about a patient associated with the patient account;
an executable portion configured for providing health care provider information, wherein health care provider information is information about one or more health care providers providing services to the patient; and
an executable portion configured for providing patient history information, wherein the patient history information details information pertaining to the care provided by the one or more health care providers.

11. The computer program product of claim 10, wherein the computer-readable program code portions further comprise:
an executable portion configured for providing an option for the user to admit a patient;
an executable portion configured for receiving direction from the health care provider to admit a patient when the user wants to admit the patient into a medical facility; and
an executable portion configured for receiving admission information from the user regarding the admission of the patient directing the medical facility receiving the patient that the user wants the patient admitted.

12. The computer program product of claim 10, wherein the computer-readable program code portions further comprise:
an executable portion configured for providing an option to the user to discharge the patient;
an executable portion configured for receiving direction from the user to discharge the patient; and
an executable portion configured for receiving discharge information from the user.

13. The computer program product of claim 10, wherein the patient demographics, the health care provider information, the admission information, and the patient history are accessible through the mobile device to allow the one or more health care providers to share patient history information with each other.

14. The computer program product of claim 10, wherein the demographic information comprises date of birth, patient's address, insurance company information or policy numbers, guardians name, contact numbers or addresses, or emergency phone numbers.

15. The computer program product of claim 10, wherein the health care provider information comprises information about a primary provider, a nurse, a resident, a specialists, a consultant, a therapist, or an attending health care provider that is part of the health care providers involved in the care of the patient.

16. The computer program product of claim 11, wherein the admission information comprises information about a location of the medical facility at which the patient is being admitted.

17. The computer program product of claim 11, wherein the admission information comprises information about a mode of transportation to a location of the facility at which the patient is being admitted, a name of the health care provider accepting the patient, or a room or bed location upon arrival of the patient.

18. The computer program product of claim 10, wherein the computer-readable program code portions further comprise:
an executable portion configured for automatically populating the patient demographics, the health care provider information, the admission information, the patient history, or the discharge information over a network based on information provided by the medical facility; and
an executable portion configured for sharing the patient demographics, the health care provider information, the admission information, the patient history, or the discharge information between the one or more health care providers over a secured shared network.

19. A method for facilitating communication between patients and caregivers, the method comprising:
allowing, by a processing device, a user to access a patient account within a patient care application over a mobile device;
providing, by the processing device, patient demographics, wherein the patient demographics are information about a patient associated with the patient account;
providing, by the processing device, health care provider information, wherein health care provider information is information about one or more health care providers providing services to the patient; and
providing, by the processing device, patient history information, wherein the patient history information details information pertaining to the care provided by the one or more health care providers.

20. The method of claim 19, further comprising:
providing, by the processing device, an option for the user to admit a patient;
receiving, by the processing device, direction from the health care provider to admit a patient when the user wants to admit the patient into a medical facility; and
receiving, by the processing device, admission information from the user regarding the admission of the patient directing the medical facility receiving the patient that the user wants the patient admitted.
